(19) United States
(12) Patent Application Publication
(10) Pub. No.: US 2018/0346303 A1
(43) Pub. Date: Dec. 6, 2018

(54) Hands Free Grating Remover

(71) Applicant: Melissa Bottoms Murray, Crosby, TX (US)

(72) Inventor: Melissa Bottoms Murray, Crosby, TX (US)

(21) Appl. No.: 15/614,785

(22) Filed: Jun. 6, 2017

(51) Int. Cl. B66F 15/00

(52) U.S. Cl. CPC B66F 15/00

(57) ABSTRACT

The Hands Free Grating Remover is a mechanical device designed for use in raising or lowering grating with a “hands free approach”. To accomplish a “hands free” approach an integral cantilever pivot point is used to apply force or remove force from one side to accomplish raising or lowering grating with the other side. For determination of safe and unsafe places to put hands, and integral color coding has been specified.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

This project is the sole intellectual property of Mrs. Melissa Murray (See attached Declaration for Utility or Design Patent Application).

### INCORPORATION-BY-REFERENCE OF MATERIAL SUBMITTED ON A COMPACT DISC

Not Applicable

### BACKGROUND OF THE INVENTION

### (1) Field of the Invention

This invention is to be used in industrial, maritime, oil production, oil refining, oil exploration, or any other setting in which grating is used as a flooring material.

### (2) Description of the Related Art Including Information Disclosed Under 37 CFR 1.97 and 37 CFR 1.98

Prior to manufacture of the Hands Free Grating Remover, when removing grating, hands and fingers are exposed to damage and injury as they are inserted below the grating to gain purchase for removal. Every year, there are numerous reported cases of loss of digits from being severed by dropped grating that is being improperly supported while it is removed. Use of this device or devices like it will remove hands and fingers from potential pinch points which lead to injury and loss.

### BRIEF SUMMARY OF THE INVENTION

The Hands Free Grating Remover will solve the problem of exposing hands and fingers to loss or damage while removing grating. The application of removal force is applied by foot powered leverage. This force is applied while workers are standing and hands and fingers are away from the line of fire.

### BRIEF DESCRIPTION OF THE SEVERAL VIEWS OF THE DRAWING(S)

FIG. 1: This is a top view of the device. This view shows the general arrangement as viewed from above of the device to include: (1) Carrying Handle and paint specification; (2) Attachment/Adjustment Hook and paint specification; (3) Texture for Footing and paint specification.

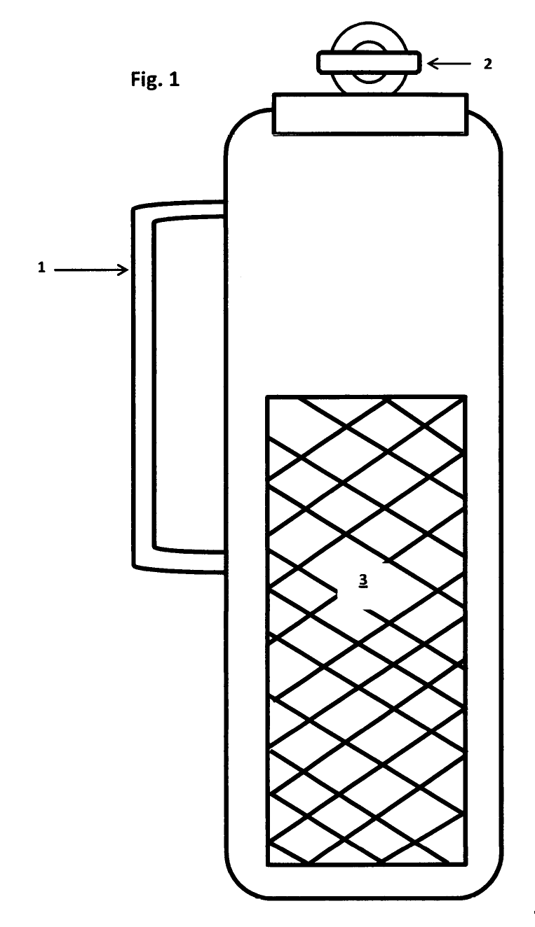

FIG. 2: This is a side view of the device. This view shows side arrangement as viewed from the right side and further shows the relationship of the components to include: (1) Carrying Handle and paint specification; (2) Attachment/Adjustment Hook and paint specification; (3) Texture for Footing and paint specification; and (4) Rounded Cantilever Pivot Point and paint specification.

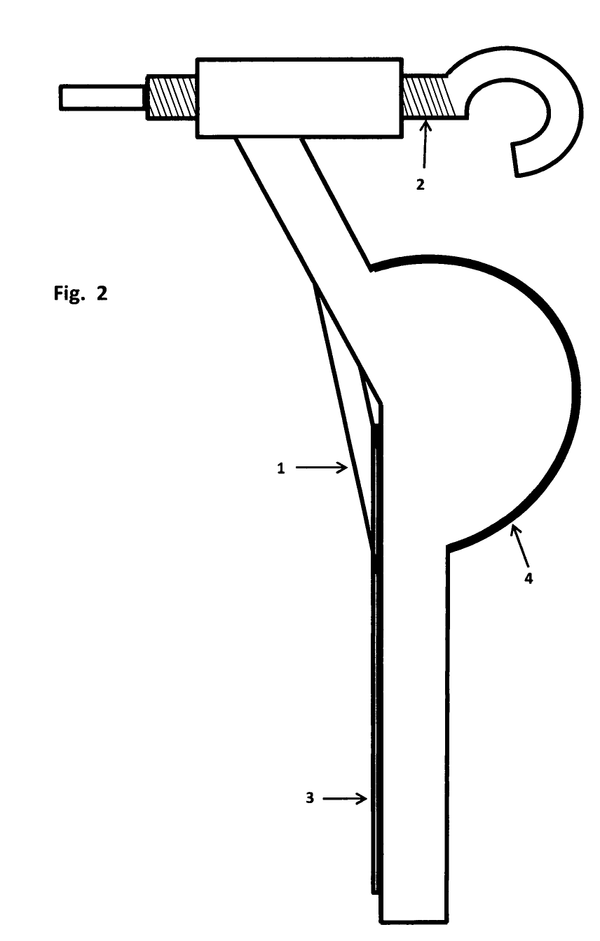

### DETAILED DESCRIPTION OF THE INVENTION

Use of the Device:
1. This device is to be used to enable raising and lowering grating in a controlled manner to prevent hand and finger injuries by removing hands and fingers from the line of fire once the device has been put in place and secured.
2. To Raise Grating: Prior to attaching this device to grating with the rounded cantilever pivot point placed on adjacent structure the retaining clips or other fastening devices whether permanent or temporary must be removed. Once fasteners are removed the Attachment/Adjustment Hook is lowered into the grating to find purchase at either a cross member or under a section of grating. The rounded cantilever pivot point is to be moved to a location such that it will pivot from a stable adjacent structural member or deck. When the operator is certain the device is securely attached and can be used, the operator will stand place one foot on the Texture for Footing (clearly marked with yellow paint) and apply downward force with his/her foot. The force will be transferred to the hook and the grating will be raised a sufficient height to allow a shim or other such device to be placed beneath it to support the weight.
3. To Lower Grating: Prior to attaching this device to the grating with the rounded cantilever pivot point placed on adjacent structure the grating must be moved to the location it will be put upon, and supported by shims or other such device(s) beneath it to support the weight. The Attachment/Adjustment Hook is lowered into the grating to find purchase at either a cross member or under a section of grating. The rounded cantilever pivot point is to be moved to a location such that it will pivot from a stable adjacent structural member or deck. When the operator is certain the device is securely attached and can be used, the operator will stand place one foot on the Texture for Footing (clearly marked with yellow paint) and apply downward force with his foot. The force will be transferred to the hook and the grating will be raised a sufficient height to allow the shim or other such device to be removed. After they are removed the operator will slowly remove the weight, applied with his/her foot, to allow the grating to be lowered under control until its weight is supported by the structure below.

### SEQUENCE LISTING

Not Applicable

1. Use of this device or similar device(s) in industrial or other settings where grating has been installed as a flooring/deck material will result in fewer injuries to hands and fingers. Past damage and injuries have been a result of grasping, lifting, hoisting, and or moving this heavy material with a “hands on approach”. By employing the device described above, hand and finger injuries will decrease dramatically while handling grating.

2. This patent to cover the device as shown in the above described drawings and detailed description or similar devices as detailed in claim 1 and further comprising of modifications employing cantilever designs intended to remove dangers to hands or fingers.

3. This patent to cover device or devices designed to raise or lower grating through mechanical means as detailed in claim 2 or further comprising of motive power by operator(s) using human power, pneumatic power, hydraulic power, and or electric power.

4. This patent to cover device or devices of similar design as detailed in claim 3 further comprising color coding of safe and unsafe areas for hand placement, as an integral component of the design.
